(19) United States
(12) Patent Application Publication
(10) Pub. No.: US 2020/0371333 A1
(43) Pub. Date: Nov. 26, 2020

(54) Microscopy method, microscope and computer program with verification algorithm for image processing results

(71) Applicant: Carl Zeiss Microscopy GmbH, Jena (DE)

(72) Inventors: Manuel Amthor, Jena (DE); Daniel Haase, Zöllnitz (DE)

(21) Appl. No.: 16/878,665

(22) Filed: May 20, 2020

(30) Foreign Application Priority Data
May 24, 2019 (DE) 102019114012.9

(51) Int. Cl. G02B 21/00; G06T 7/00

(52) U.S. Cl. CPC G02B 21/0076; G06T 2207/20081; G06T 2207/20084; G06T 7/0014

(57) ABSTRACT

A microscopy method for sample examination comprises at least the following steps: recording at least one microscope image; supplying the at least one microscope image to an image processing algorithm, which outputs an image processing result; supplying the image processing result to a verification algorithm, which comprises a machine learning algorithm that has been trained using reference images and associated reference verification results; ascertaining a verification result by way of the verification algorithm using the trained machine learning algorithm and based on the supplied image processing result; and outputting the verification result. A computer program comprises a corresponding verification algorithm for checking in an analogous manner image processing results of microscope images.

### REFERENCE TO RELATED APPLICATIONS

The current application claims the benefit of German Patent Application No. 102019114012.9, filed on 24 May 2019, which is hereby incorporated by reference.

### FIELD OF THE DISCLOSURE

The present invention relates to a microscopy method for sample examination. The invention additionally relates to a computer program and to a microscope for sample examination.

### BACKGROUND OF THE DISCLOSURE

In a generic microscopy method for sample examination, at least one microscope image is recorded using a microscope. The at least one microscope image is supplied to an image processing algorithm. The image processing algorithm processes the at least one microscope image and outputs an image processing result. A corresponding generic microscope comprises: a radiation source, for example a light source, for irradiating a sample; a detector/a camera for recording microscope images; optics elements for guiding radiation that is to be detected, in particular detection light, from the sample to the detector; and an electronic control and evaluation unit, which can also be considered as a computer or part of a computer and is configured for performing an image processing algorithm. The image processing algorithm is designed to calculate an image processing result from at least one recorded microscope image and to output it.

The microscope can be a light microscope, an X-ray microscope, or a microscope that is designed differently in principle as desired. A microscope image recorded with the microscope is typically processed in automated fashion by one or more image processing algorithms of different types. Image processing algorithms are used for example to discern objects in a microscope image. In particular, an image processing algorithm can be designed to identify particular sample regions within the microscope image, which are then zoomed in on in automated fashion and are examined at a higher magnification. If the image processing algorithm provides an incorrect image processing result, an incorrect region within the microscope image could be identified as the sample region. Images that are subsequently recorded of this region are then useless. In the case of an automatic microscope adjustment based on an incorrect image processing result, a collision with the sample or a sample vessel or a sample holder may even occur. As a consequence, the sample or the microscope itself could be damaged.

In order to avoid the aforementioned problems of incorrect image processing results as far as possible, the image processing algorithm can in principle be designed to calculate confidence intervals for its ascertained image processing result. Such a functionality, however, is closely linked to the image processing algorithm and can be added only with effort to existing image processing algorithms. In the case of a change of the image processing algorithm or the use of new image processing algorithms, the confidence level determination must in each case be newly developed. These disadvantages make a verification of image processing results by way of confidence intervals laborious in practice. Moreover, some incorrect image processing operations are easily discernible for a person but identifiable only unreliably by way of confidence intervals. For example, the image processing algorithm can be designed to divide/assign the image points in a recorded microscope image into the three categories “sample”, “surrounding sample vessel edge” and “rest/other”. A sample vessel edge or periphery typically has a regular shape, for example circular or rectangular. An identified shape that deviates from such regular shapes to an extreme extent can be easily discerned as incorrect by a person, whereas the calculated confidence interval suggests under certain circumstances a high quality of the incorrect image processing result.

A fundamental check of image processing results by a user is undesirable and in particular impractical in the case of a large quantity of samples to be examined, for example thousands or hundreds of thousands of samples.

It can be considered to be an object of the invention to specify a microscopy method, a microscope and a computer program with which a disadvantageous further use of incorrect image processing results is avoided, as far as possible.

### SUMMARY OF THE DISCLOSURE

This object is achieved by the microscopy method of claim 1, the microscope of claim 15 and the computer program of claim 17.

Advantageous variants of the invention are the subject of the dependent claims and are additionally discussed in the following description.

In the microscopy method of the abovementioned type, the image processing result is fed, according to the invention, into a verification algorithm. The verification algorithm comprises a machine learning algorithm that has been trained using reference images and reference verification results. The verification algorithm uses the trained machine learning algorithm to ascertain, based on the supplied image processing result, a verification result, which is then output.

In the microscope of the abovementioned type, the electronic control and evaluation unit is set up correspondingly, according to the invention, for performing a verification algorithm. The verification algorithm comprises a machine learning algorithm that has been trained using reference images and reference verification results. In addition, the verification algorithm is designed to ascertain and output a verification result using the machine learning algorithm and based on the image processing result.

The computer program of the invention comprises instructions that, upon execution of the program by a computer, cause the latter to carry out the following steps: supplying an image processing result of an image processing algorithm to a verification algorithm, which comprises a machine learning algorithm that has been trained using reference images and reference verification results; and ascertaining and outputting a verification result by way of the verification algorithm using the machine learning algorithm and based on the supplied image processing result.

The input of the verification algorithm is thus the output image processing result of the image processing algorithm. The image processing result may be a processing image or a processing image stack. A processing image stack, as it is called, is a plurality of processing images that represent sections that are for example offset in height and together form a 3D image. A processing image may be a two-dimensional pixel matrix, whereby a plurality of image points arranged in rows and columns form the processing image. A processing image may also be formed by geometric information, for example by a definition of object boundaries (“bounding boxes”). Bounding boxes may form for example a circle, ring or polygon shape and indicate the position thereof within the microscope image. In this case, the processing image does not need to be defined by individual image points but may be described by a list of segments found or bounding boxes.

One example which the present disclosure will discuss at several locations in the specification for the sake of better understanding is the cover slip edge determination. In this case, the image processing algorithm identifies cover slip edges in a microscope image. The image processing result may be a processing image in which the respective image pixels of the microscope image that correspond to the cover slip edges are marked/identified. Alternatively, the shape and location of a bounding box may be indicated as the image processing result, for example the size, orientation and location of a square shape in the case of a square cover slip.

Since only the image processing result is supplied to the verification algorithm, the mode of function of the image processing algorithm does not need to be known or taken into account to ascertain the verification result. In this, the verification algorithm differs from a confidence interval determination, for which individual calculation operations of the image processing algorithm need to be known and taken into account. In the aforementioned example, the shape and location of a bounding box are supplied to the verification algorithm as an image processing result. Correct image processing results may, for example, have in common that the ascertained cover slip edges always represent a square shape or a square shape that is possibly distorted by the optical imaging. In the case of incorrect image processing results, by contrast, bounding boxes that have been ascertained can form entirely irregular shapes, without any similarity to a square shape. Such a shape does not correspond to the square cover slip that is presumably being used and should therefore be classified as an incorrect image processing result.

The verification algorithm additionally differs from known assessment methods for image processing results in that a machine learning algorithm that has been trained using reference images and reference verification results is used. The reference images correspond to the image processing results and not for example to the microscope images. In the aforementioned example, reference images in which the regular square shape of the cover slip periphery is marked are thus taken into account. From these reference images, the machine learning algorithm learns rules to detect whether there is a sufficiently great correspondence in the image processing result (that is to say in the image with marked cover slip edges that is output by the image processing algorithm) to the learned reference images with a square cover slip edge shape so that it is possible to state that cover slip edges are correctly marked in the image processing result. The reliability of detecting incorrect image processing results can be significantly better here than in known methods that use confidence intervals or other information relating to the image processing result derived from the image processing algorithm itself. The reference images can be learned together with a respective reference verification result that provides information on how the respective reference image was classified (in particular by a person), for example either as “correct image processing result” or “incorrect image processing result.” The reference images used may be assigned in each case the same reference verification result, according to which for example all reference images used are classified either as a “correct image processing result” or all are classified as an “incorrect image processing result.” Here, a machine learning algorithm of unsupervised learning can be used. Alternatively, the respective reference images may also be assigned different reference verification results, according to which for example some of the reference images are classified as correct image processing results and others as incorrect image processing results. Here, a machine learning algorithm of supervised learning may be used.

The reference images with which the machine learning algorithm is trained may originate from the image processing algorithm, that is to say they can represent image processing results for microscope images. Here, the appropriate verification result, i.e. the reference verification result, was provided by a user. This makes it possible to use the verification algorithm for any desired image processing algorithms whose concrete calculation contents do not need to be known or further taken into account. The verification algorithm may thus also be used with new, updated or different image processing algorithms. Only a plurality of image processing results output by the image processing algorithm need to be supplied as reference images to the machine learning algorithm. In this case, reference images that are appropriate for the respective measurement situations may be used. For example, a series of measurements may be performed, in which samples are located in circular wells of multiwell plates. Here, the sample vessel peripheries, that is to say circular well peripheries, are intended to be detected by the image processing algorithm. Accordingly, image processing results in which the circular peripheries were identified are supplied as reference images—in contrast to the above-described case, in which a square cover slip periphery is intended to be detected and, accordingly, reference images in which square shapes were marked would have been used.

Training using only reference images that are assigned the same reference verification result can be advantageous for example if an image processing algorithm already operates with a very high reliability. In this case, under certain circumstances, a user has available only correct image processing results which can be used as reference images for training. The machine learning algorithm then ascertains commonalities of the reference images and subsequently outputs a positive verification result for image processing results that are to be checked if sufficiently high-level commonalities with the reference images are ascertained. If not, a negative verification result is output, wherein degrees of the verification result of more than two values are also possible.

The verification algorithm may be designed to ascertain the verification result based on the supplied image processing result without the microscope image(s) being supplied to it. Since the verification algorithm does not need to perform any special processing of the microscope images, it is possible to use a plurality of entirely different microscope images and image processing algorithms with the same verification algorithm.

Alternatively, it is however also possible that the at least one microscope image is additionally supplied to the verification algorithm and the verification algorithm also ascertains the verification result in dependence on the supplied microscope image. Here, the training data of the machine learning algorithm can also comprise microscope images. In particular, the training data can be triplets with: 1) microscope images; 2) image processing results calculated therefrom by way of the image processing algorithm (reference images), and 3) reference verification results, in particular a classification of the reference images provided by a user into correct or incorrect image processing results. The machine learning algorithm can hereby use in particular information in the microscope image that was incorrectly processed or not taken into account by the image processing algorithm. For example, the microscope images can be overview images in which a microscope slide or a multiwell plate with a plurality of wells is visible. A text or a label can be present on the microscope slide or the multiwell plate, such as a manufacturer name. The location of the text or manufacturer name can always be located for example at the same position relative to the wells or the sample/the samples or provide information as to how many wells or sample regions should be present in the overview image. The text can provide additional information with which the verification algorithm can ascertain whether an image processing result (for example the positions and the number of multiwell wells in an overview image) is correct. The microscope images in such cases can also be used to establish in the learning procedure a criterion depending on which correct image processing results differ (for example that circular multiwell wells should be present in the overview image in the case of a particular manufacturer logo, while square multiwell wells should be present in the overview image in the case of a different or no manufacturer logo).

The image processing algorithm can be designed in principle in any way to calculate from one or more microscope images one or more images that are referred to here as image processing results. For example, the image processing algorithm can be designed to achieve an improved image quality by way of denoising or deconvolution. Alternatively or additionally, the image processing algorithm can also be designed for microscopy-specific calculations, as are used for example in SIM (Structured Illumination Microscopy) or PALM (Photoactivated Localization Microscopy). In the case of SIM, the image processing algorithm calculates a single image from a plurality of microscope images as the image processing result, wherein the microscope images differ in the illumination used with respect to the orientation and phase of a structured illumination.

The image processing algorithm can comprise in particular a segmentation algorithm, which divides a microscope image into different segments. This can serve for object classification, for example for classifying sample regions and sample-free regions within the recorded microscope image or for classifying a sample carrier periphery/edge, cover slip periphery or sample vessel periphery within the recorded microscope image. For these purposes, the image processing algorithm can alternatively also be a detection algorithm, which determines bounding boxes. The image processing result can, as described above, either indicate coordinates of the bounding box(es) or indicate a particular class for each image pixel of the microscope image. One exemplary use can be the determination of proportions of stone types in microscope images of drill core sections. In this case, the classification relates to different stone types. The at least one microscope image is formed by a microscope image stack, that is to say by a plurality of microscope images corresponding to different sections of the same drill core. Another use is counting (biological) cells in a microscope image. In this case, for example, the cell walls/membranes are ascertained as bounding boxes, wherein the number of such bounding boxes, which are in each case closed, is the variable of interest. The image processing result is here not the number of the cells, but an image in which the cell walls/membranes are marked. Owing to the regular shape of cells, for example having an oval or circular cross section, a machine learning algorithm is suitable for verification of the results.

The verification algorithm can also be designed to enable a user to input application-specific additional information, for example relating to the frequency distribution of expected objects. For example, if biological cells are identified, it is possible to indicate how many cells there typically are or to indicate a maximum number of cells as additional information. The verification algorithm additionally uses this additional information to assess an image processing result. In the example of segmentations, the additional information provided by a user can also be an object shape, for example a circle shape or a square shape, if the image processing algorithm is intended to find cover slip edges or sample vessel edges.

Depending on the image processing algorithm used, specific artefacts can typically occur, that is to say errors in the calculated image that do not represent object structures but are due to the calculation operations of the image processing algorithm. This can occur for example in convolution calculations. A known case of image artefacts is also wave-type patterns produced owing to JPG compression in the region of edges, that is to say next to abrupt image brightness changes in the microscope image. The machine learning algorithm can now have been trained using reference images that contain undesirable artefacts, wherein associated assessments of these reference images (reference verification results) were indicated for example by a person. The verification algorithm now ascertains whether the supplied image processing result contains undesirable artefacts and outputs a verification result that is dependent thereon. Image artefacts are a further example of errors that frequently cannot be reliably detected by way of confidence intervals or other conventional calculation methods for ascertaining the accuracy of the image processing result. By contrast, the verification algorithm in the invention can comprise a machine learning algorithm that was trained specifically for detecting such artefacts. As has also been noted previously, the machine learning algorithm for this purpose requires absolutely no information relating to how the image processing algorithm works or how artefacts are produced in the image processing algorithm.

Frequently, the microscope images from one measurement series have similarities, as a result of which it may make sense to train the machine learning algorithm for the measurement series at hand. For example, the measurement series can comprise a group of overview images, which each show a multiwell plate having a plurality of circular wells. The image processing algorithm is here intended to identify for example all well peripheries. Correct image processing results then correspond in the fact that circular or ring-shaped well peripheries in corresponding sizes, arranged in rows and columns, were ascertained. More generally, it is possible for a training that is individualized for a group of microscope images to be performed. In this case, the image processing algorithm calculates for each microscope image of the group a respective image processing result. Subsequently an input option is made available to a user to select a fraction (i.e., some) of these image processing results as reference images and to assign them (in each case) a reference verification result. In the aforementioned example, the user accordingly selects a few image processing results in which, from the user's viewpoint, a plurality of well peripheries of a multiwell plate have been correctly identified. Subsequently, the verification algorithm uses the selected fraction of image processing results for training the machine learning algorithm and then calculates a respective verification result for the remaining image processing results using the learned machine learning algorithm. In this way, the machine learning algorithm can be used with a plurality of different image processing algorithms without the need for a calculation operation of the image processing algorithm to be known to define thereby a calculation step of the verification algorithm. Nevertheless, the verification algorithm can be adapted for the present group of microscope images and the selected image processing without the user being burdened with demanding tasks. The input option for the user for selecting a fraction/some of the image processing results as reference images can for example be designed such that a plurality of image processing results in a reduced image resolution are displayed next to one another on a screen and the user can select a variable number of these images by clicking them. As was described elsewhere in more detail, provision can be made for the user to mark only correct or only incorrect image processing results, and thus the user does not need to indicate a reference verification result for each selected image processing result. Alternatively, an input option for reference verification results may be provided for a user, for example to input whether the respectively selected image processing result is correct or incorrect.

The verification algorithm can be designed to perform different further steps in dependence on the verification result, which is described in more detail below.

In some invention variants, the verification algorithm is designed to control the microscope for subsequent image recordings in dependence on the verification result. For example, a planned measurement procedure may only be continued if the verification algorithm indicates that the image processing result is correct. In particular, the microscope image can be an overview image in which the image processing algorithm identifies a sample region for a subsequent detail examination. However, this detail examination is performed only if the verification algorithm deems the image processing result to be correct.

The verification algorithm can also be configured to output, in dependence on the verification result, a warning to a user and/or to store the image processing result together with an error note for the purpose of a later error analysis. The verification algorithm can also be designed to start an Internet communication service in the case of a negative verification result and to send information to a remote server, for example of the microscope manufacturer. The information sent can comprise the image processing result and, if desired, the associated microscope image and an error warning produced by the verification algorithm.

The verification algorithm can also be designed to calculate and output a corrected image processing result in dependence on the verification result. If the machine learning algorithm of the verification algorithm has been trained for example for detecting artefacts that do not, however, render the entire image unusable, the verification algorithm can change the image regions of the artefacts and output a correspondingly corrected image processing result.

Furthermore, the verification algorithm can be designed to initiate, in the case of a verification result that indicates incorrect image processing, another performance of the image processing algorithm, but with changed image processing parameters. Image processing parameters can relate for example to the sensitivity of the edge identification; to sharpening/blurring in particular before further processing steps; to a change in image contrast in particular before further processing steps; to smoothing of ascertained edges; or to a sensitivity with which variably bright image regions are identified as the same object.

Alternatively or additionally, the verification algorithm can also be designed to initiate, in the case of a verification result that indicates incorrect image processing, a new recording of a microscope image with subsequent image processing by way of the image processing algorithm and verification by way of the verification algorithm. The new recording of a microscope image can be initiated in particular if repeated performance of the image processing algorithm with changed image processing parameters previously always provided an image processing result that was deemed to be incorrect by the verification algorithm. The new recording of a microscope image can be taken with changed microscope parameters. The changed parameters can relate for example to the radiation intensity or duration of the sample, the exposure time of the camera chip or filters used in the microscope beam path.

The verification algorithm can also be designed to display, in the case of a verification result that indicates incorrect image processing, the associated microscope image and the associated image processing result on a screen and to offer the user the option to correct the incorrect image processing result by way of an input means, e.g., by marking areas in a displayed image or entering numerical parameters. The microscope image and the associated image processing result can be displayed on the screen for example one next to the other or in overlaying fashion. In the case of the object identification, the user can be offered for example the option to draw a bounding box in the microscope image or in the image processing result by way of the input means. Subsequently, the bounding box drawn by the user is used further in place of the bounding box that was ascertained by the image processing algorithm, for example for counting objects or for singling out bounded objects and the magnified image recording thereof. Provision may be made for this display on the screen to take place if the image processing result was deemed to be incorrect. If that is not the case, the method can proceed to a next planned method step, in particular controlling the microscope in dependence on the image processing result, for example magnified recording of an ascertained image detail or ascertaining a suitable focus setting at a location defined by the image processing algorithm.

The computer program described can be executed in particular on a computer that is operatively connected to a microscope or to the microscope described or is part of said microscope. In particular, the electronic control and evaluation unit of the microscope can be configured for performing the computer program. The image processing algorithm described can be part of the computer program. Alternatively, the computer program can receive the result of the image processing algorithm as the input. The computer program can also serve for evaluating microscope images that were recorded earlier and therefore does not need to be executed on a computer that is connected to the microscope or interacts therewith.

The electronic control and evaluation unit can be embodied by in principle any desired electronic components, wherein the functions thereof are programmed in software, hardware or a mixture of software and hardware. The electronic control and evaluation unit can be arranged locally at the site of the remaining microscope components. Alternatively, the electronic control and evaluation unit or parts thereof can also be arranged at a remote site and interact with remaining microscope components via a data link. For particularly fast or efficient performance of the verification algorithm, the electronic control and evaluation unit or the computer can also comprise a graphics card. The graphics card is used to perform the machine learning algorithm or specific calculation steps of the verification algorithm, such as training of the machine learning algorithm or assessing the image processing results.

The machine learning algorithm can comprise an algorithm of supervised or unsupervised learning, as is also mentioned above. In the case of supervised learning, the machine learning algorithm ascertains, from the reference images and from the reference verification results that are indicated in relation to the former, a mapping function which is then used to map an image processing result onto a verification result. The verification result can represent a quality factor that can have two values or any desired number of discrete or continuous values. In the case of unsupervised learning, no respective reference verification result needs to be indicated, wherein, owing to the selection of the reference images (for example only correct image processing results), all reference images correspond to the same (reference) verification result, for example only a correct verification result. The machine learning algorithm now derives from an image processing result a verification result or a quality factor, based on deviations between the image processing result and the reference images. A deep learning algorithm or another learning algorithm that is known in principle can be used for the machine learning algorithm. For example, a convolutional neural network (CNN) can be used, in particular for the classification or regression of individual image regions or of a total image output by the image processing algorithm into a quality class or to a quality factor. Alternatively, it is also possible to use segmentation CNNs, which assess and possibly change a segmentation by way of the image processing algorithm, if desired based on the microscope images. A detection CNN can also be used, which marks regions that were identified as problematic. For unsupervised learning, a deep autoencoder algorithm can be used, for example, which interprets deviations of an image processing result from reference images as an uncertainty measure.

A microscope image is an image recorded using the microscope. This image can also be calculated by way of measurements that run successively, for example in a sample scan. The sample to be examined is located generally in the illuminated plane, which is imaged sharply onto the detector for recording a microscope image. However, the sample does not necessarily need to be visible in the microscope image, for example because it is too small in an overview image or if the intention is first to ascertain position or focus settings by way of the microscope image before the sample is examined with a changed illumination setting.

A verification result may relate to the complete image output by the image processing algorithm. Alternatively, the verification result may comprise a plurality of partial results for various regions of the image output by the image processing algorithm. This enables differentiation, according to which some image regions can be assessed as having been processed correctly and other image regions can be assessed as having been processed incorrectly. The verification result that is output can also be an image in which the regions that have been identified as being incorrect are marked.

A reference verification result prescribed by the user in the case of supervised learning can comprise the following: a notation, for example “correct” and “incorrect”; a numerical value for assessing the quality, such as a number between 0 and 100; an error position indication in the reference image, optionally with associated notation or numerical quality assessment; and/or a manually corrected image processing result, for example changed image segmentation. In the case of a machine learning algorithm of unsupervised learning, by contrast, only the reference images, if desired with associated microscope images from which the image processing algorithm has calculated the reference images, are used; the same reference verification result is assumed here for all reference images, for example “correct image processing”.

The described optional features of the invention can be part of the method of the invention, the microscope of the invention, or the computer program of the invention. The microscope can in particular be designed for performing the method variants according to the invention. Analogously, variants of the method according to the invention result from the intended use of embodiments of the light microscope according to the invention. The computer program can in particular comprise instructions by way of which the described verification algorithm and, if desired, also the image processing algorithm and the control that is dependent on the verification result can be performed if the computer program is executed on a computer.

### BRIEF DESCRIPTION OF THE DRAWINGS

A better understanding of the invention and various other features and advantages of the present invention will become readily apparent by the following description in connection with the schematic drawings, which are shown by way of example only, and not limitation, wherein like reference numerals may refer to alike or substantially alike components:

FIG. 1 shows a schematic illustration of a flowchart of a method according to an exemplary embodiment of the invention;

FIG. 2 schematically shows reference images, as are used for training the machine learning algorithm of the microscope or computer program according to exemplary embodiments of the invention;

FIG. 3 schematically shows a microscope according to an exemplary embodiment of the invention.

Identical and identically acting constituent parts are generally identified by the same reference signs in the figures.

### DETAILED DESCRIPTION OF EMBODIMENTS

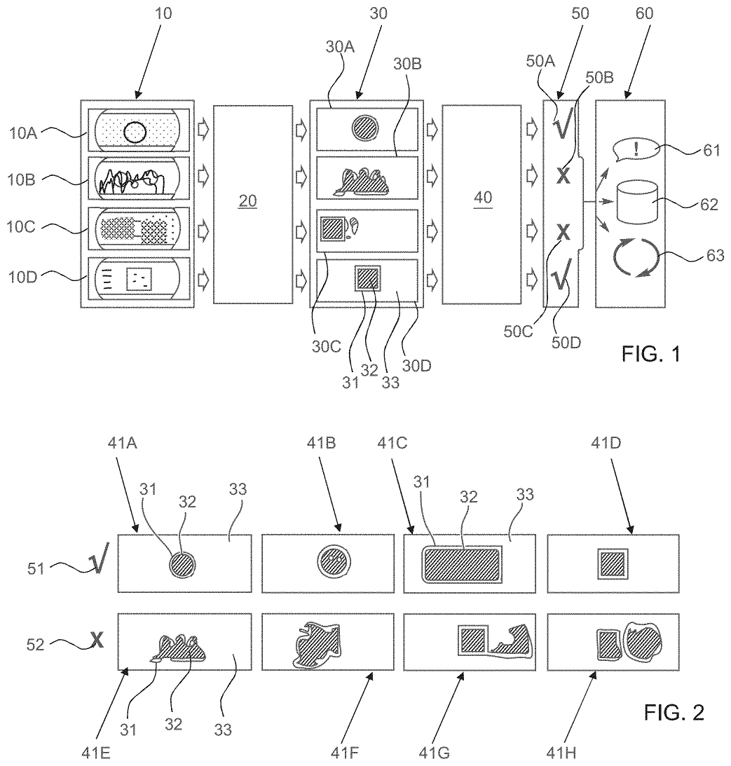

FIG. 1 schematically shows the steps of an exemplary embodiment of the microscopy method according to the invention.

Images recorded using a microscope, microscope images 10, 10A-10D below, are supplied to an image processing algorithm 20. The image processing algorithm 20 can be designed in a manner that is known in principle and can serve for example to perform a segmentation of the microscope images 10, 10A-10D. In the process, the image processing algorithm 20 detects and classifies different objects in the microscope images 10, 10A-10D. In the example illustrated, microscope images 10, 10A-10D were recorded in a measurement situation in which a sample to be examined was located between a microscope slide and a cover slip. The image processing algorithm 20 is to identify in the microscope images 10, 10A-10D in each case a cover slip periphery/edge 31, a cover slip region 32 under which the sample can be located, and a remaining environment 33. The image processing algorithm 20 outputs an image processing result 30, 30A-30D, which is a processed image. In the present example, the image processing algorithm 20 has provided for each microscope image 10, 10A-10D an image processing result 30, 30A-30D in which an identified cover slip region 32, an identified cover slip periphery 31 and the remaining background 33 are marked differently.

The image processing algorithm 20 was able to correctly detect a rectangular cover slip in the microscope image 10D; the associated image processing result 30D correctly shows the square shape of the cover slip periphery/edge 32. Within the region of the cover slip periphery 31, the cover slip region/the sample 32 was correctly detected, while the cover slip periphery 31 is correctly surrounded by a background 33.

By contrast, the image processing algorithm 20 was not able to correctly detect the cover slip in the microscope image 10B. In the associated image processing result 30B, a cover slip periphery is marked in a shape that does not occur in practice; in addition, the cover slip periphery is of variable thickness and is not continuous.

The segmentation into cover slip region, cover slip periphery and background is also incorrect in the image processing result 30C. Although the rectangular cover slip was detected, regions located next to it are incorrectly likewise marked as cover slip region and cover slip edge.

The microscope image 10A, in turn, was processed correctly, and the cover slip region, the cover slip/sample vessel periphery and the background are correctly indicated in the associated image processing result 30A.

While conventional methods are not capable of satisfactorily detecting incorrect image processing results 30B, 30C, this becomes possible in embodiments of the invention owing to a verification algorithm 40. The image processing results 30, 30A-30D are supplied to the verification algorithm 40. It comprises a machine learning algorithm 45, which is trained to calculate a verification result 50 from the respective image processing result 30, 30A-30D. The associated verification result 50B, 50C indicates for the image processing results 30B, 30C that the image processing was incorrect. By contrast, the verification results 50A, 50D indicate that the associated image processing results 30A, 30D are correct. In the illustrated example, the verification results indicate only two different values: “correct” or “incorrect”. However, other verification results or a greater number of different verification results can also be possible in other embodiments.

In dependence on the present verification result 50, 50A-50D, a control device 60 performs control 62, 63 or information output 61, which will be described in more detail below.

First, there will be a discussion with respect to FIG. 2 of how the machine learning algorithm 45 of the verification algorithm 40 has been trained. Different image processing results that the image processing algorithm 20 has calculated from recorded microscope images are supplied to the machine learning algorithm 45 as training data. The image processing results used for the training are referred to here as reference images 41A-41H. In the illustrated example, the reference images 41A-41H were calculated by an image processing algorithm that comprises a segmentation algorithm and has divided regions in each microscope image into different classes, presently into “cover slip region” 32, “cover slip periphery” 31 and “background” 33. Further classes can also be provided; for example, two regions within the cover slip region were detected and classified as “sample” in the reference image 41B by way of the image processing algorithm.

For each reference image 41A-41H, an associated verification result is specified, which is referred to as reference verification result 51, 52. The reference verification result can be specified by a person. For the reference images 41A-41D, “image processing correct” was indicated as the reference verification result 51. By contrast, “image processing incorrect” was assigned as the reference verification result 52 to the reference images 41E-41H. Especially in the case of the image processing shown by way of example, that is to say a segmentation or classification of image data, it is frequently easy for persons to recognize whether an image processing result can be correct or if, for example, the detected cover slip shape does not exist in reality. Known image processing algorithms contain no satisfactory checking or assessment steps for reliably checking the ascertained result. To achieve this, the machine learning algorithm 45 is used. It is trained using the reference images 41A-41H and the associated reference verification results 51, 52 to establish criteria by which it assigns one of the (reference) verification results 51 or 52 to an unknown image processing result 30, 30A-30D. In other words, the machine learning algorithm 45 determines a hypothesis, that is to say a map that assigns a verification result to each image processing result. It is important in this case that the reference images used for training are not recorded microscope images but images therefrom that have been processed using the image processing algorithm and are referred to here as image processing results.

In a modification of the embodiment shown, the machine learning algorithm 45 can also have been trained using only reference images that are assigned the same reference verification result, for example using only the reference images 41A-41D.

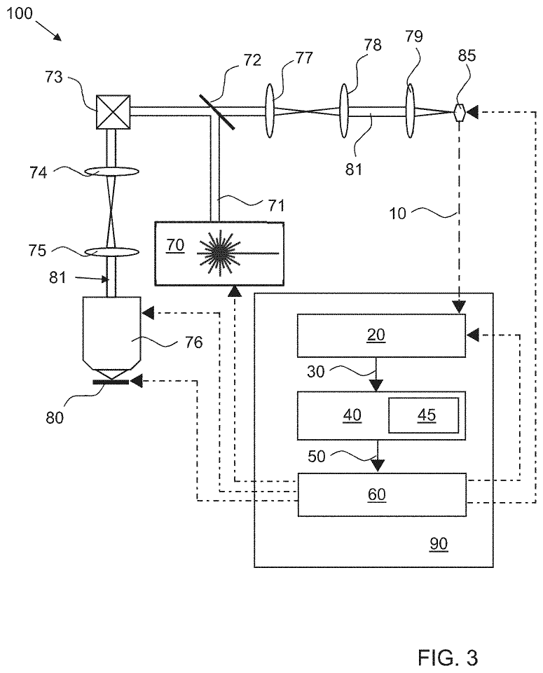

One exemplary embodiment of a microscope 100 according to the invention will now be described with reference to FIG. 3. The microscope 100 comprises a light source 70, which emits illumination light 71 in the direction of a sample 80. The light source 70 may comprise for example one or more LEDs or lasers. The illumination light 71 is guided via optics elements 72-76 to the sample. The optics elements may optionally comprise a scanner 73 and an objective 76 for focussing the illumination light 71 at a specific sample plane. The light coming from the sample will be referred to below as detection light 81. This may be radiation that is emitted after excitation of a molecule by way of absorption of the illumination light upon transition into a lower-energy molecule state, such as in the case of fluorescence light. Alternatively, it can also be reflected or scattered illumination light or, in different setups, transmitted illumination light. The detection light 81 is guided via optics elements 72-79 to a light detector 85. In the example illustrated, both illumination light 71 and detection light 81 is guided via the optics elements 72-76. The element 72 is a beam splitter, which is reflective for detection light 81 or illumination light 71 and is transmissive for the respective other light 71 or 81. Rather than using such a descanned reflected-light arrangement, it is also possible to measure in transmitted light or with dark-field illumination, wherein the illumination light 71 and the detection light 81 do not need to be guided via the same optical elements. The light detector 85 can comprise a camera chip with which microscope images are recorded, as described with respect to the previous figures.

The microscope 100 comprises an electronic control and evaluation unit 90, which contains the image processing algorithm 20 already described and the verification algorithm 40 with the machine learning algorithm 45. Microscope images 10 are transmitted from the detector 85 to the image processing algorithm 20, which outputs for each microscope image 10 an associated image processing result 30 to the verification algorithm 40. The latter calculates for each image processing result 30 a verification result 50, which is output to a control device 60 of the electronic control and evaluation unit 90. The control device 60 performs various steps in dependence on the verification result 50. For example, it can drive the image processing algorithm 20 to process again microscope images 10 for which the ascertained image processing result 30 produced a negative verification result 50. Changed image processing parameters are chosen in that case. Alternatively, the control device 60 can drive the light source 70 or the detector 85 in the case of a negative verification result to change illumination or detection parameters and to record another microscope image of the same sample region. In particular, lateral coordinates of the imaged sample region can remain the same for the new recording of a microscope image, but the illumination intensity, illumination duration, illumination wavelength or exposure or integration time of the detector 85 can be changed. The control device 60 can also be configured to drive and adjust the objective 76, a sample stage for moving the sample 80 and/or the scanner 73 depending on the verification result 50, in particular to continue, in the case of a positive verification result 50, with a sample examination with changed microscope settings. The different control steps that can be performed by the control device 60 are denoted with the reference signs 61-63 in FIG. 1. Control step 61 here denotes an information output of the verification result to a user. Provision can be made for this to be done only for negative verification results 50B, 50C, wherein the microscope image 10B, 10C associated with the negative verification result 50B, 50C is displayed to a user as being placed next to or, in partially transparent form, overlaid with the image processing result 30B, 30C. The user is offered the option to change the image processing results 30B, 30C, for example by drawing other bounding boxes or segmentations on the screen using a marking tool. Corrected image processing results are then used further in the same way as image processing results with correct verification results 50A, 50D, for example by recording subsequent sample images based on the image processing results, in particular magnified recordings of marked image details.

In modifications of the exemplary embodiment illustrated, rather than using the light microscope, a different microscope that does not irradiate the sample with visible radiation is used. The light source can be replaced by a radiation source, for example an X-ray source. The detector is sensitive to the radiation used. Optics elements that are used are focussing and/or deflection elements suitable for the respective radiation, such as (metallic) mirrors having optionally curved surfaces or magnets for focussing or deflecting radiation. Aside from light and X-ray sources, radiation sources that emit an electron or ion beam are also conceivable.

An exemplary embodiment of the computer program according to the invention comprises the verification algorithm 40, with the machine learning algorithm 45, described with reference to FIG. 1. Reference images as described with respect to FIG. 2 are used in this case. The image processing algorithm described with respect to FIG. 1 and the functions of the control device 60 can optionally also be part of the computer program. The computer for performing the computer program can be formed by the control and evaluation unit 90.

A reliable automation can be provided by the described checking of the results of image processing of recorded microscope images. This reduces the risk that entire measurement series are recorded or evaluated incorrectly due to a microscope image that is evaluated incorrectly. The danger of damage that could occur for example as a result of a collision between the objective 76 and the sample 80 owing to the microscope being driven based on incorrect image processing is also minimized.

### LIST OF REFERENCE SIGNS

10, 10A-10D Microscope image
20 Image processing algorithm
30, 30A-30D Image processing results
31 Sample carrier periphery, cover slip periphery or sample vessel periphery identified in the microscope image
32 Cover slip region, under which a sample can be located, identified in the microscope image
33 Background or sample-free region identified in the microscope image
40 Verification algorithm
41A-41H Reference images
45 Machine learning algorithm
50, 50A-50D Verification results
51, 52 Reference verification results
60 Control device
61-63 Steps initiated by the control device 60
70 Light source
71 Illumination light
72-79 Optics elements

### 80 Sample

81 Detection light

### 85 Camera

90 Electronic control and evaluation unit

### 100 Microscope

We claim:

1. A microscopy method for sample examination, comprising at least the following steps:
recording at least one microscope image;
supplying the at least one microscope image to an image processing algorithm, which outputs an image processing result;
supplying the image processing result to a verification algorithm, which comprises a machine learning algorithm that has been trained using reference images and associated reference verification results;
ascertaining a verification result by way of the verification algorithm using the trained machine learning algorithm and based on the supplied image processing result; and
outputting the verification result.

2. The microscopy method of claim 1,
wherein the reference images that were used to train the machine learning algorithm are produced by the image processing algorithm.

3. The microscopy method of claim 1,
wherein the machine learning algorithm has been trained using reference images that are assigned in each case the same reference verification result.

4. The microscopy method of claim 1,
wherein the image processing result is a processing image or a processing image stack.

5. The microscopy method of claim 1,
wherein the microscope image is additionally supplied to the verification algorithm and the verification algorithm ascertains the verification result also in dependence on the supplied microscope image.

6. The microscopy method of claim 1,
wherein the verification algorithm ascertains the verification result based on the supplied image processing result without the at least one microscope image being supplied to the verification algorithm.

7. The microscopy method of claim 1, further comprising
performing an individualized training for a group of microscope images in that the image processing algorithm calculates for each microscope image of the group a respective image processing result and
a user is presented with an input option for selecting a fraction of these image processing results as reference images and assigning them a respective or a common reference verification result,
wherein the verification algorithm uses the selected fraction of image processing results for training the machine learning algorithm and subsequently calculates for the remaining image processing results a respective verification result with the trained machine learning algorithm.

8. The microscopy method of claim 1,
wherein the machine learning algorithm has been trained using reference images containing undesirable artefacts and using associated reference verification results,
the verification algorithm ascertains whether the supplied image processing result contains undesirable artefacts and outputs a verification result that is dependent thereon.

9. The microscopy method of claim 1,
wherein the image processing algorithm is a segmentation algorithm for object classification, or
the image processing algorithm is a detection algorithm for determining bounding boxes.

10. The microscopy method of claim 9,
wherein the segmentation algorithm is configured for classifying sample regions and sample-free regions within the recorded microscope image or for classifying a sample carrier edge, cover slip edge or sample vessel edge within the recorded microscope image,
or the detection algorithm is configured for determining at least one of sample boundaries, sample carrier boundaries, cover slip boundaries and sample vessel boundaries.

11. The microscopy method of claim 1,
wherein an electronic control and evaluation unit controls the microscope for subsequent image recordings in dependence on the verification result.

12. The microscopy method of claim 1,
wherein, in the case of a verification result that indicates incorrect image processing, the verification algorithm initiates to perform the image processing algorithm again, but with changed image processing parameters.

13. The microscopy method of claim 1,
wherein the verification algorithm initiates, in the case of a verification result that indicates incorrect image processing, a new recording of a microscope image with subsequent image processing by way of the image processing algorithm and verification by way of the verification algorithm.

14. The microscopy method of claim 1,
wherein the verification algorithm displays, in the case of a verification result that indicates incorrect image processing, the associated microscope image and the associated image processing result on a screen for a user and offers the user the option to correct the incorrect image processing result by way of an input means.

15. A microscope, comprising:
a radiation source for irradiating a sample;
a detector for recording microscope images;
optics elements for guiding detection radiation from the sample to the detector; and
an electronic control and evaluation unit, which is configured for performing an image processing algorithm;
wherein the image processing algorithm is designed to calculate an image processing result from at least one recorded microscope image and to output it;
wherein the electronic control and evaluation unit is configured for performing a verification algorithm;
the verification algorithm comprises a machine learning algorithm that has been trained using reference images and reference verification results; and
the verification algorithm is designed to ascertain and output a verification result using the trained machine learning algorithm and based on the image processing result.

16. The microscope of claim 15,
wherein the radiation source is a light source and the detection radiation is detection light.

17. A computer program comprising instructions that, upon execution of the program by a computer, cause the latter to carry out at least the following steps:
supplying an image processing result of an image processing algorithm to a verification algorithm, which comprises a machine learning algorithm that has been trained using reference images and reference verification results; and
ascertaining and outputting a verification result by way of the verification algorithm using the trained machine learning algorithm and based on the supplied image processing result.
